(19) United States
(12) Patent Application Publication
(10) Pub. No.: US 2014/0295809 A1
(43) Pub. Date: Oct. 2, 2014

(54) CALL STATUS INDICATING METHOD AND USER EQUIPMENT USING THE SAME

(71) Applicant: Acer Incorporated, New Taipei City (TW)

(72) Inventor: Sathiyakeerthi Madasamy, New Taipei City (TW)

(73) Assignee: Acer Incorporated, New Taipei City (TW)

(21) Appl. No.: 14/226,846

(22) Filed: Mar. 27, 2014

Related U.S. Application Data
(60) Provisional application No. 61/805,531, filed on Mar. 27, 2013.

(51) Int. Cl. H04M 3/42; H04W 4/16

(52) U.S. Cl. CPC H04M 3/42042; H04W 4/16
USPC 455/414.1

(57) ABSTRACT

The present disclosure proposes a status indicating method applicable to a user equipment and a user equipment using the same method. The proposed call status indicating method would include establishing a radio resource connection (RRC), performing a subscriber authentication procedure in response to establishing the RRC connection, transmitting or receiving a call setup message in which the call status is indicated within the call setup message in response to performing the subscriber authentication procedure, and performing a radio bearer setup procedure in response to transmitting or receiving the call status embedded in the call setup message. The call status would be indicated in an information element (IE) of the setup message such as an Important Status IE of the setup message.

### CROSS REFERENCE TO RELATED APPLICATION

This application claims the priority benefit of U.S. provisional application serial no. 61/805,531, filed on Mar. 27, 2013. The entirety of the above-mentioned patent application is hereby incorporated by reference herein and made a part of specification.

### TECHNICAL FIELD

The present disclosure generally relates to a call status indicating method applicable to a user equipment and a user equipment using the same method.

### BACKGROUND

Currently whenever a calling party makes a call to the called party using an electronic device, in most cases the called party may either know the identity of the calling party or the phone number of the calling party. However, under existing communication protocols, regardless whether a call is through a radio access network or through an internet protocol (IP) network, the called party would not be able to discern the importance of the call based on the information transmitted from the network. For example, at this time, when a called party receives a phone call, the called party would only typically see the information of the calling party but there is no way to know the urgency of the phone call. Also the calling party does not have a way to indicate whether the phone call is a high priority phone call or a low priority phone call.

In more specific detail, FIG. 1A illustrates an example of an outgoing call establishment procedure taken f according to a version of a Third Generation Partnership Long Term Evolution (3GPP LTE) specification such as TS 51.010-1 V. 8.0.0, and FIG. 1B illustrates an example of an incoming call establishment procedure taken from Also according to a version of a 3GPP LTE specification such as TS 51.010-1 V. 8.0.0. Similar descriptions for outgoing and incoming call establishment could also be found in TS 24.008. In general, when a calling party makes a call using one's mobile phone or other types of electronic devices, the caller would enter or choose a phone number having a specific digits and a prefix serving as an area code. In response to entering the phone number, the mobile phone would establish a wireless radio resource connection (RRC) with a base station. After RRC connection has been established, authentication procedures would be performed as the subscriber information would be authenticated by the network. After the authentication procedures have been completed, the mobile phone of the caller party would transmit a call setup message to the network, and the call setup message would essentially include all the necessary information needed for the network to arrange the phone call such as a phone number of the called party. In response to receiving the call setup message, the called party would be alerted by the network, and then a radio bearer setup procedure would be conducted among the network, the called party, and the calling party in order to setup the subsequent phone conversation.

However, the problem with the above mentioned call procedure is that the network currently has no means of receiving a call status information and delivering the call status indication to the called party. Also a calling party does not have a mean of entering the call status indication. A calling party could only enter an area code and a phone number and then the call would be dialed. Therefore, a different call procedure would need to be implemented in order for a calling party to indicate the call status of a phone call and also for the network to deliver the call status indication from the device of the calling party to the target device of the called party.

### SUMMARY OF THE DISCLOSURE

Accordingly, the present disclosure is directed to generally relate to a call status indicating method applicable to a user equipment and a user equipment using the same method.

A call status indicating method applicable to a user equipment comprising establishing a radio resource connection (RRC), performing a subscriber authentication procedure in response to establishing the RRC connection, transmitting or receiving a call setup message in which the call status is indicated within the call setup message in response to performing the subscriber authentication procedure, and performing a radio bearer setup procedure in response to transmitting or receiving the call status embedded in the call setup message.

In one of the exemplary embodiments, during the establishment of an incoming or out going call, the call status would be indicated in an information element (IE) of the setup message.

In one of the exemplary embodiments, during the establishment of an incoming or out going call, the call status would be indicated in an information element (IE) “Important Status” of the setup message.

In one of the exemplary embodiments, during the establishment of an out going call, a call status would be received from an input, and a call setup message would then be generated to include the call status. The RRC would be established with a mobile originating establishment cause, and then the call status would be delivered to a network through the RRC with the network.

In one of the exemplary embodiments, during the establishment of an incoming call, a paging message would be received as an alert, and the in response to receiving the paging message, RRC connection with a network would be established with a RRC mobile terminating establishment cause. The call setup message would then be received from the network over the RRC, and the call status could be obtained from the call setup message.

In one of the exemplary embodiments, the call status would include three possible discrete levels emergency, high, and low.

In one of the exemplary embodiments, the three possible discrete levels of emergency, high, and low could be represented by three different bit values of the Important Status IE of the setup message.

In one of the exemplary embodiments, the call status could be indicated by a phone number to be dialled, wherein the phone number could include a pre-fix of a specific sequence of digits such that the pre-fix could be mapped to a specific call status.

In one of the exemplary embodiments, the call status could be indicated on a display of the user equipment with different visual representations for different call statuses.

In one of the exemplary embodiments, the call status could be indicated with different audio representation.

The present disclosure also proposes a user equipment which contains at least but not limited to a transceiver for transmitting and receiving data and a processor coupled to the transceiver and configured for establishing through the transceiver a radio resource connection (RRC), performing a subscriber authentication procedure in response to establishing the RRC connection through the transceiver, transmitting or receiving through the transceiver a call setup message in which the call status is indicated within the call setup message in response to performing the subscriber authentication procedure, and performing through the transceiver a radio bearer setup procedure in response to transmitting or receiving the call status embedded in the call setup message.

In order to make the aforementioned features and advantages of the present disclosure comprehensible, preferred embodiments accompanied with figures are described in detail below. It is to be understood that both the foregoing general description and the following detailed description are exemplary, and are intended to provide further explanation of the disclosure as claimed.

It should be understood, however, that this summary may not contain all of the aspect and embodiments of the present disclosure and is therefore not meant to be limiting or restrictive in any manner. Also the present disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A illustrates a typical outgoing call establishment procedure according to a version of a 3Gpp specification.

FIG. 1B illustrates a typical outgoing call establishment procedure taken from a version of a 3Gpp specification.

FIG. 2A illustrates an implementation of the call status indicating method with an exemplary network.

FIG. 2B illustrates an implementation of the call status indicating method with handheld mobile electronic devices in accordance with one of the exemplary embodiments of the present disclosure.

FIG. 3 illustrates a signal flow chart for implementing the call status indicating method in accordance with one of the exemplary embodiments of the present disclosure.

FIG. 4A illustrates an exemplary setup message content along the direction of a user equipment to a wireless network.

FIG. 4B illustrates an exemplary setup message content along the direction of a wireless network to a user equipment.

FIG. 5A illustrates a call setup procedure from the perspective of a caller in accordance with one of the exemplary embodiments of the present disclosure.

FIG. 5B illustrates a call setup procedure from the perspective of a callee in accordance with one of the exemplary embodiments of the present disclosure.

FIG. 6 illustrates the call status indicating method in accordance with one of the exemplary embodiments of the present disclosure.

FIG. 7 illustrates an exemplary user equipment in terms of functional block diagrams in accordance with one of the exemplary embodiments of the present disclosure.

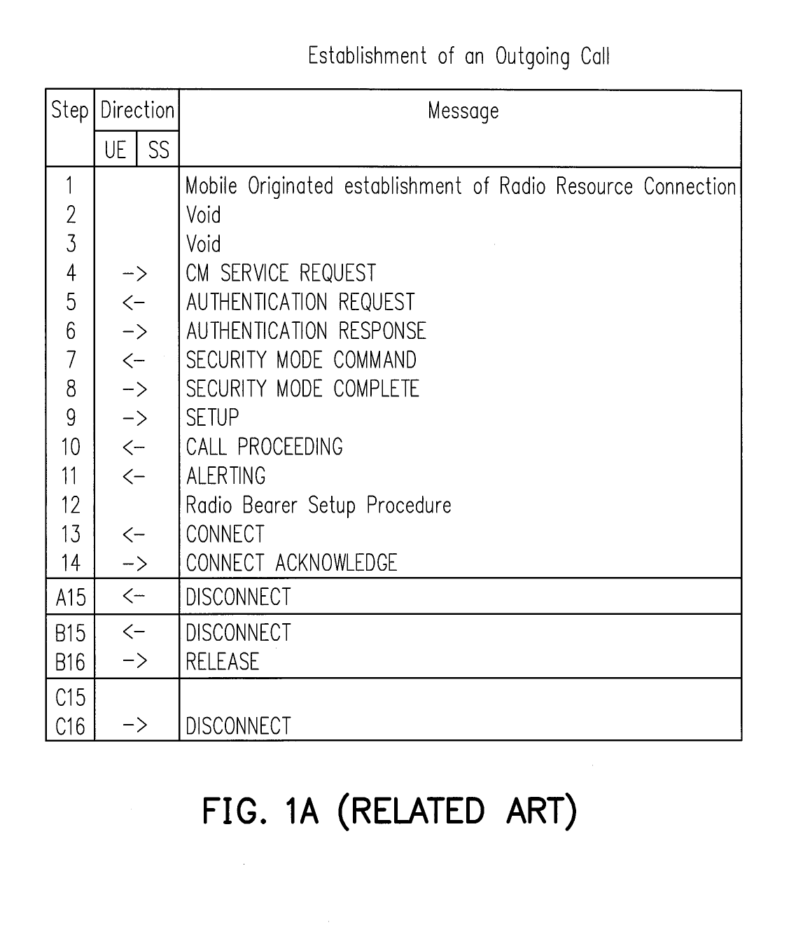

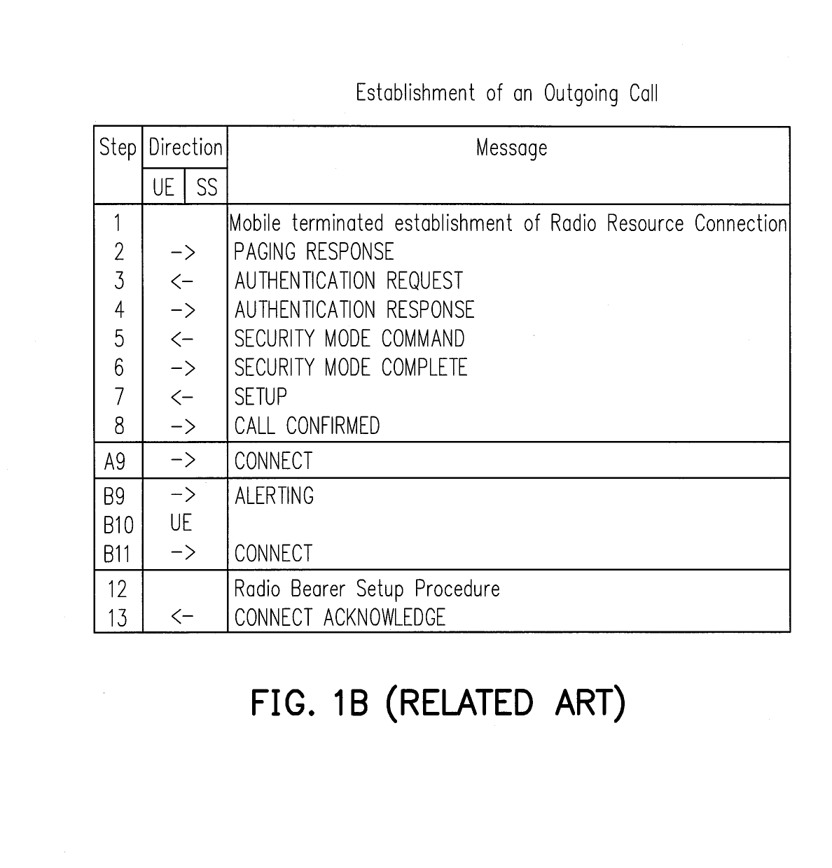

### DETAILED DESCRIPTION OF DISCLOSED EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

Whenever a calling party places a phone call to a called party, the called party could not understand the severity or importance of an incoming call of the calling party. In this situation, the called party may avoid or ends the incoming call if the called party is busy engaging an activity such as attending meets, driving, or walking even though the incoming call could be extremely urgent and important as the calling party would require immediate attention. One of the goals of the present disclosure is to avoid this situation.

The calling party could convey the status of a call by first indicating the call status in one's phone before making the call. The call status could be indicated through a custom user interface having hardware or software buttons. For example, if the dialing application of a phone contain soft buttons, by pressing a particular soft button to dial the phone call, a call status would be indicated by the corresponding soft button, and the call status would subsequently transmitted to the network along with the phone conversation. The call status could also be indicated by the prefix of a phone number. A particular prefix could be mapped to a specific call status which would then be transmitted to the network. The call status would be transmitted from the mobile phone to the network in an information element of a call setup message. For instance, an IE “calling user important status” within the call setup message could be used to indicate the call status. The device of the called party could also receive the call status via the call setup message during the establishment of an incoming call. When the called party is being paged by an incoming call, the called party would be able to see the call status on the screen of the mobile device.

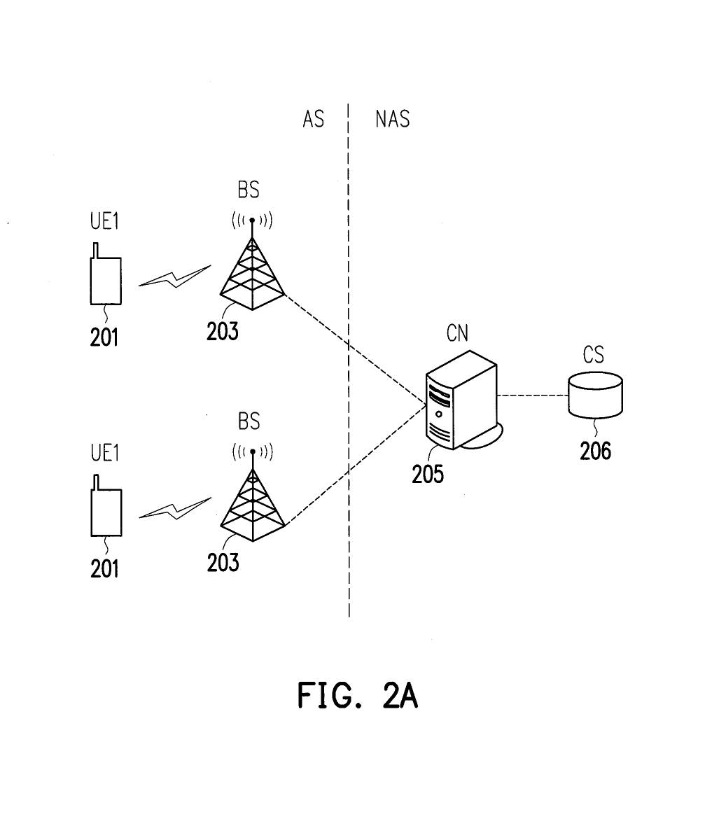

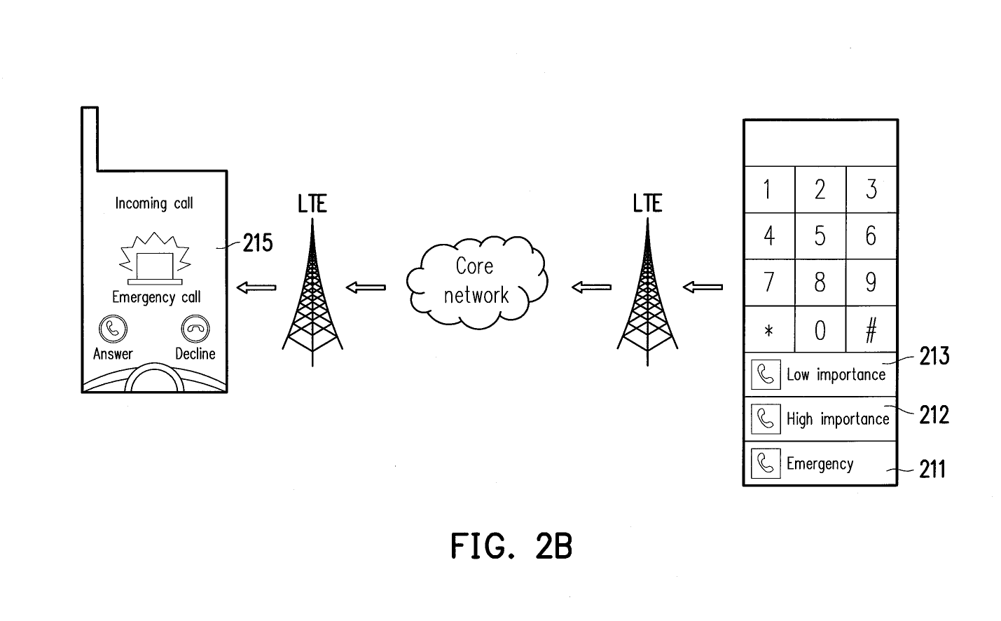

FIG. 2A illustrates an implementation of the call status indicating method with an exemplary network. The exemplary network may contain at least but not limited to UE1 201 which in this example is a caller and also UE2 202 which in this example is a callee. After the caller places a call, the UE1 201 establishes a RRC with the base station 203. The call would then be routed to a charging server 206 such as the Home Subscriber Server (HSS) through a network control node 205 which could be a mobility management entity (MME) for a LTE communication system for subscriber authentication. After the subscriber authentication is completed, the call could then be routed to the callee 202 through the serving base station 204 of the callee 202.

FIG. 2B illustrates an implementation of the call status indicating method with user equipments such as handheld mobile electronic devices in accordance with one of the exemplary embodiments of the present disclosure. In order for a handheld mobile electronic device to implement the proposed call status indicating method, a user of the caller party could select one of three options, namely Emergency 211, High Importance 212, and Low Important 213, shown on a screen of a handheld mobile electronic device. The three options could be hardware buttons or software buttons. A user may first dial a phone number, and then select one of the three options to decide whether the call is a call of low importance, high importance, or emergency. In response to selecting one of the three options, the call would be handled by a wireless network such as a LTE network which routes the call to a called party through a core network. Assuming that a caller party had selected Emergency by activating the Emergency button 211, the screen 215 of the called party would alert the user of the called party with a corresponding graphical display, and the user equipment or the mobile device of the called party would also alert the user with a corresponding ring tone which would be associated with an emergency call. Similar concepts could be extended to a High Importance call or a Low Importance call.

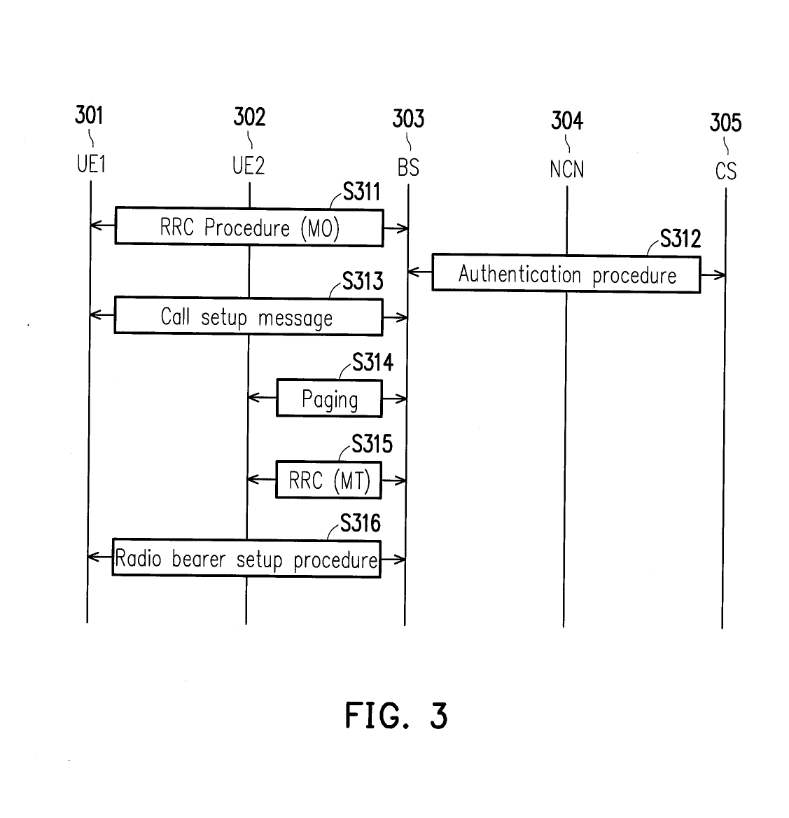

FIG. 3 illustrates a signal flow chart for implementing the call status indicating method in accordance with one of the exemplary embodiments of the present disclosure. For FIG. 3, UE1 301, UE2 302, NCN 304, and CS 305 could be equivalent to UE1 202, UE2 202, BS 203, NCN 205, and CS 206 of FIG. 2 respectively except that both UE1 301 and UE2 302 would be assumed to under the domain of the same base station 303. The proposed procedure would include at least but not limited to step S311˜S316. In step S311, UE1 301 begins a phone call over a radio access network by performing a RRC establishment procedure with a mobile originating establishment clause with the serving base station 303. In step S312, the BS 303 would route the call to a network control node 304 such as MME and then to a charging server 305 to process the subscriber authentication. In step S313, UE1 would transmit a call setup message to the BS 303. Based on the call set up message, the base station would read the information elements (IE) of the call setup message and could obtain the call status from an information element which indicates the call status. Such IE could be the important status IE. After the call setup message is obtained, in step S314, the BS 303 would page UE2 302 to alert UE2 302 of the incoming call. In step S315, UE2 302 would establish the RRC with a mobile terminating establishment cause with the BS 303 in order to receiving the incoming call. In step S316, the network would arrange for the radio bearer setup procedure to be completed among UE1 301, UE2 302, and the BS 303 so that UE1 301 could start talking to UE2 302.

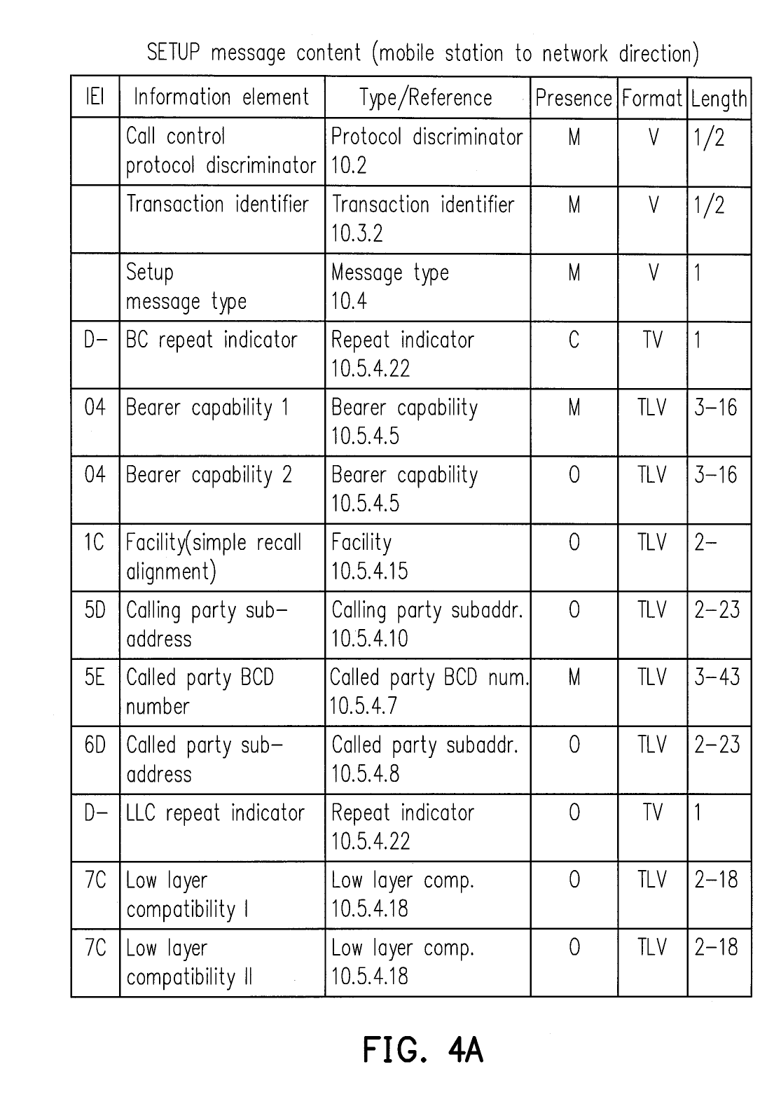

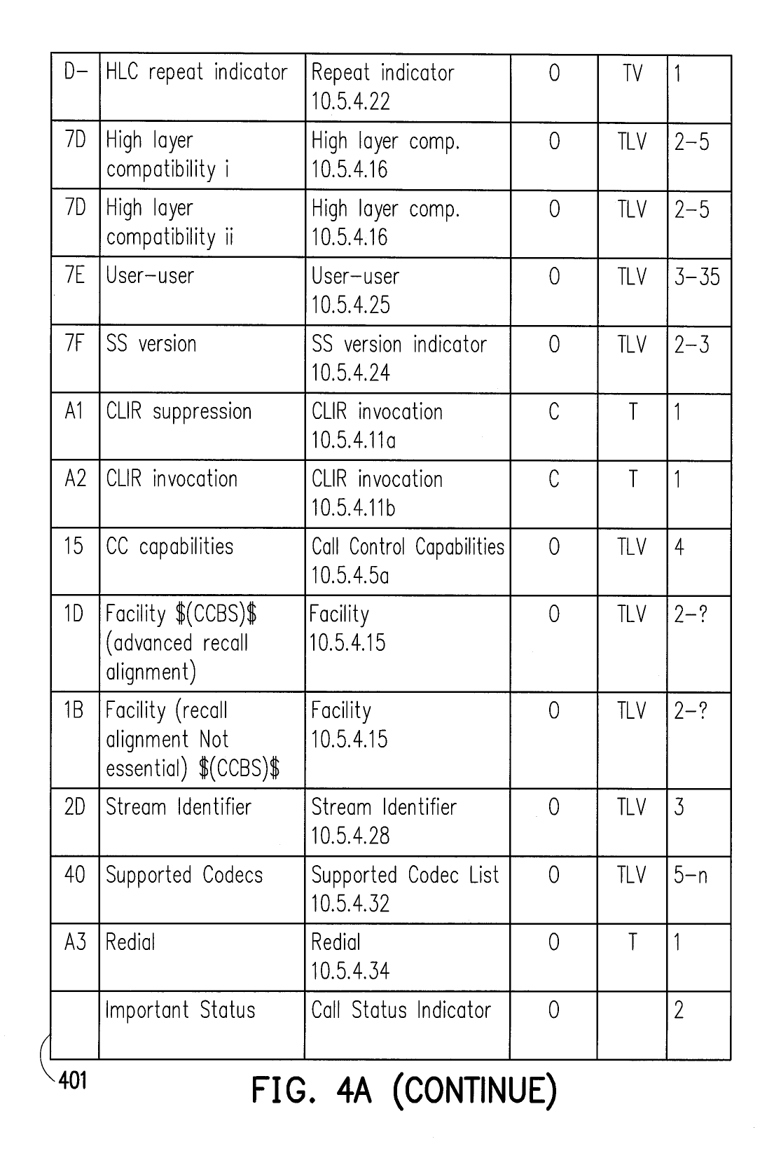

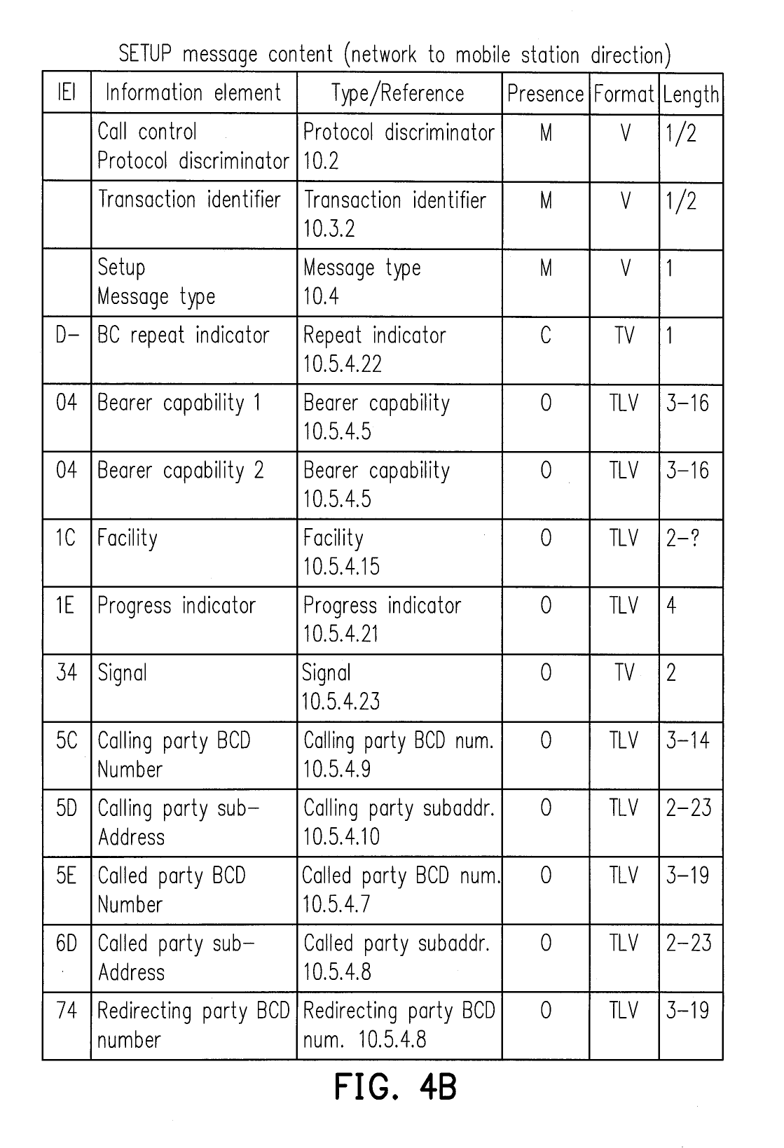

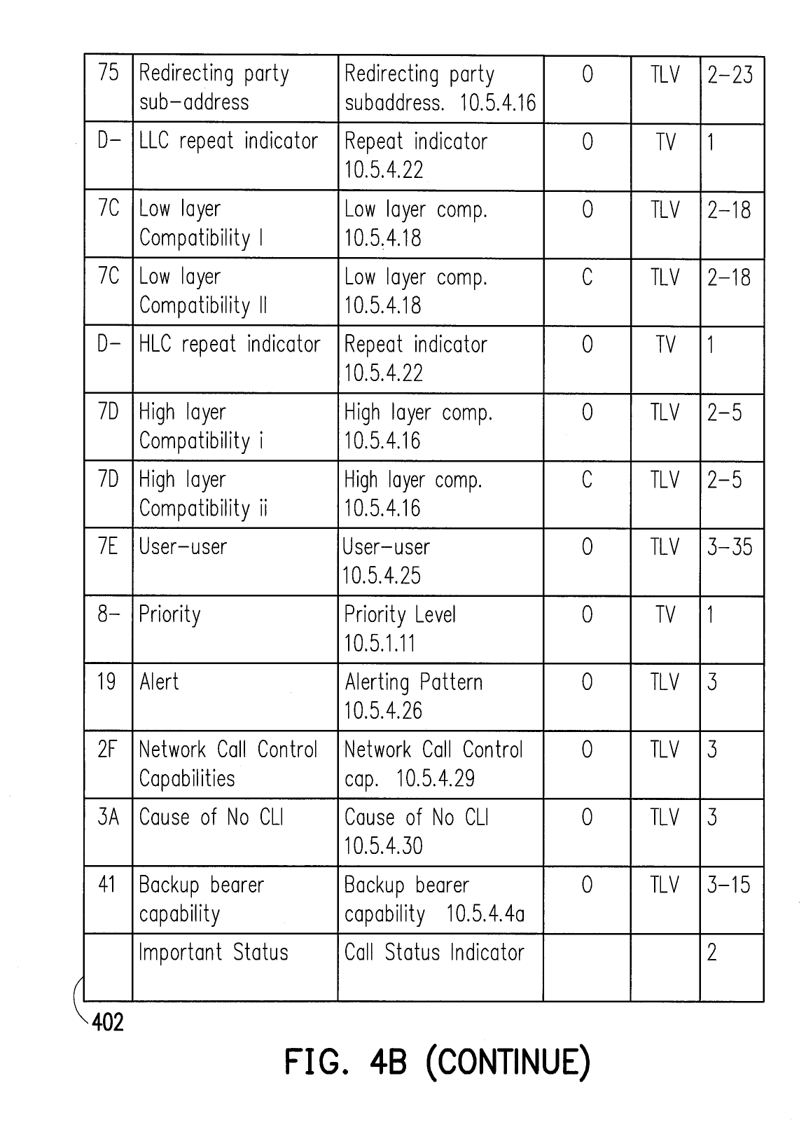

FIG. 4A illustrates an exemplary setup message content along the direction of a user equipment to a wireless network. In the field 401, the IE named such as important status could contain the call status, and the IE could be at least 2 bits to represent three different call statuses. For example, bits 10 of the important status IE could indicate an emergency call, bit 01 could indicate a high priority call, and bit 00 could indicate a low priority call. However, the exact value of these bits is merely exemplary and should be construed as limitation to the present disclosure.

FIG. 4B illustrates an exemplary setup message content along the direction of a wireless network to a user equipment. Similar to FIG. 4A, the field 402 would include a binary value with each different binary value indicating a different call status such that at least two bits could indicate up to four different call statuses.

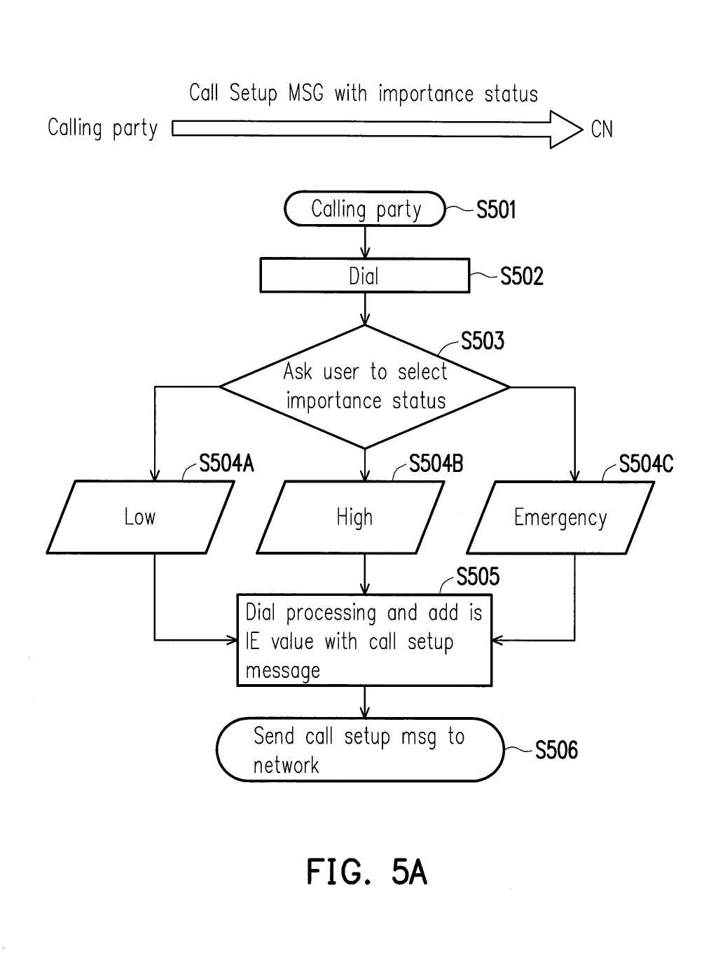

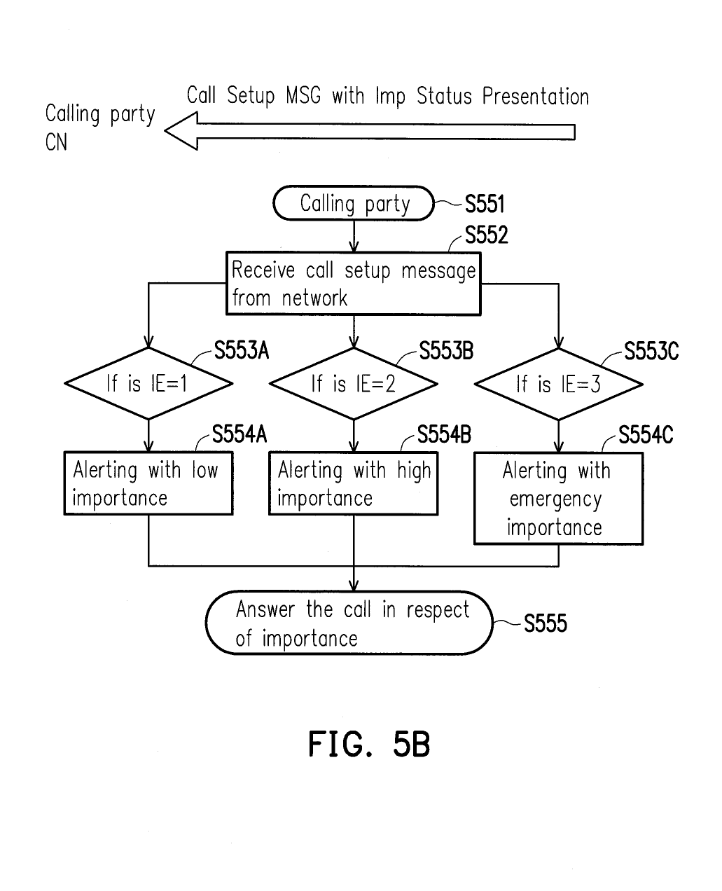

FIG. 5A illustrates a call setup procedure from the perspective of a caller in accordance with one of the exemplary embodiments of the present disclosure. In step S501, a caller may select a called party to make a phone call. In step S502, the caller would activate a soft or hard button to dial the number. In step S503, the user interface of the electronic device would ask the user for the priority or status of the call, and the user may select one of the steps S504A, S504B, and S504C to indicate emergency, high priority, or low priority respectively. In step S505, in response to the user selecting a call status in one of steps S504A, S504B, and S504C, the processor of the electronic device of the caller would add the value corresponding to the selected call status to the IE within the call setup message. In step S506, the electronic device of the caller would transmit the call setup message to the serving network.

FIG. 5B illustrates a call setup procedure from the perspective of a callee in accordance with one of the exemplary embodiments of the present disclosure. In step S551, the called party would have received a call. In step S552, the electronic device of the called party would have received a call set up message from a serving network. In steps S553A˜S553C, the electronic device would determine the value of the IE which contains the call status information from the call set up message. In this example, if the bit value is 01, than the electronic device would consider the call as low importance. If the bit value is 10, then the electronic device would consider the call as high importance. If the bit value is 11, then the electronic device would consider the call as emergency which needs to be responded immediately. In steps S554A˜554C, the electronic device would generate alert based on the determined call status and would generate an alert of low importance, high importance, and emergency respectively in steps S554A˜S554C. The generated alert could be an audio alert or a visual alert. If the electronic device is a mobile phone for example, the visual alert could be different types of visual representation on the touch screen, and the audio alert could be different types of ring tones or vibrations.

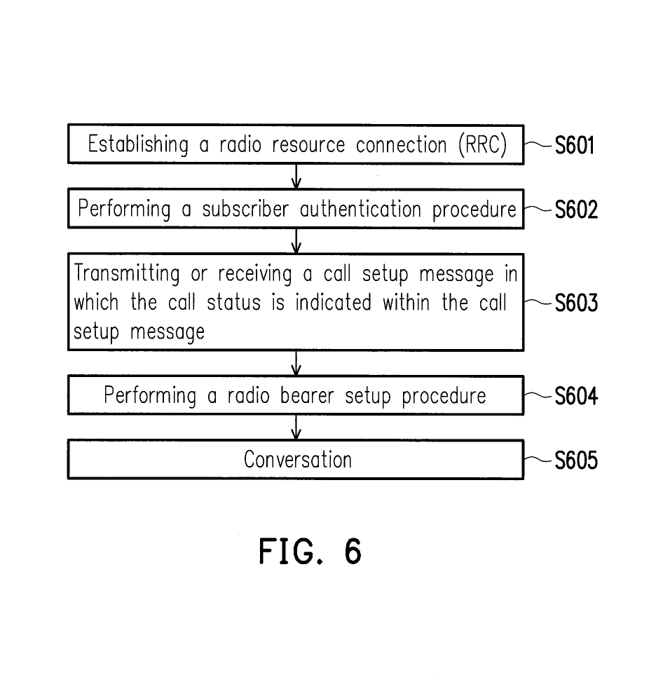

FIG. 6 summarizes the call status indicating method from the perspective of a user equipment in accordance with one of the exemplary embodiments of the present disclosure. In step S601, the user equipment would establish a radio resource connection (RRC) with a serving base station. In step S602, the user equipment would transfer necessary information to the serving base station in order to have its subscription status verified. In step S603, the user equipment would transmit to or receive from a base station a call set up message in which the call status would be indicated within the call setup message. In step S604, the user equipment would perform a radio bearer setup procedure with the serving base station and the called party in order to have a phone conversation. In step S605, a conversation would take place between the calling party and the called party.

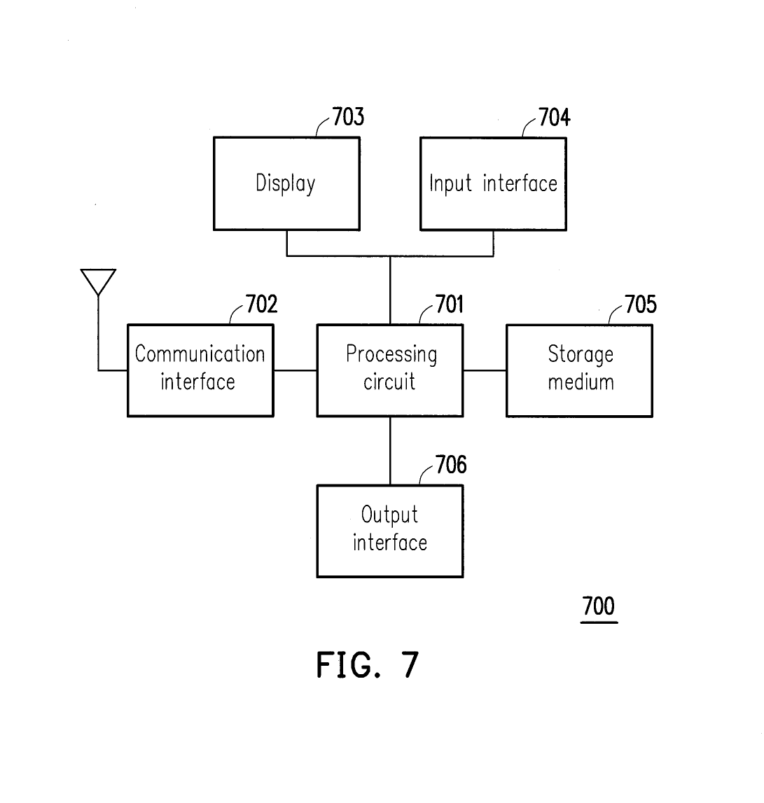

FIG. 7 illustrates an exemplary user equipment 700 in terms of functional block diagrams in accordance with one of the exemplary embodiments of the present disclosure. The user equipment would include at least but not limited to a processing circuit or processor 701. The processor would be coupled to a communication interface 702, a display 703, an input interface, a storage medium 705, and an output interface 706. The processor 701 may also include a controller. The processor may include a micro-controller, a North Bridge, a South Bridge, a field programmable array (FPGA), a programmable logic device (PLD), an application specific integrated circuit (ASIC), or other similar device, or a combination thereof. The processor 701 may also include a central processing unit (CPU) or a programmable general purpose or special purpose microprocessor, a digital signal processor (DSP), a graphics processing unit (GPU), an application specific integrated circuit (ASIC), a programmable logic device (PLD), or other similar device or a combination thereof, which is used for processing all tasks of the exemplary mobile electronic device and would execute functions related to the proposed method as illustrated in FIGS. 2-6 of the present disclosure.

The communication interface 702 could include components such as a protocol unit which support signal transmissions of a global system for mobile communication (GSM), a personal handy-phone system (PHS), a code division multiple access (CDMA) system, a wireless fidelity (Wi-Fi) system or a worldwide interoperability for microwave access (WiMAX). The communication interface circuit 702 would also provide wireless access for the device 700 by including components at least but not limited to a transmitter circuit and a receiver circuit.

The display 703 could include a touch screen and may contain a display such as a liquid crystal display (LCD), a light-emitting diode (LED) display, a field emission display (FED) or other types of display.

The input interface 704 could be, for example, an input device such as a mouse, a keyboard, a joystick, a wheel, and so forth and would receive an input operation from a user. The input interface 704 may also include a resistive, a capacitive or other types of touch sensing device which would be integrated as a part of the touch screen 703. From the input interface, a user may type words or enter numbers to place a phone call. The user may also enter a call indication from the input interface 704.

The storage medium 705 could volatile or permanent memories which would store buffered or permanent data such as compiled programming codes used to execute functions of the exemplary mobile electronic device.

The output interface 706 may include a speaker which provides audio alert when a user receives a call and provides audio representation to indicate the call status of the call.

In view of the aforementioned descriptions, the present disclosure provides a mean to indicate a call status and to transmit the call status from a calling party to a called party so that the called party would be able to know the call status (e.g. low, high, and emergency) of a calling party. If the caller party finds oneself in an emergency situation under which the caller's life is threatened or the timing is critical, the caller may be able to contact the called party using the emergency status.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

Moreover, the claims should not be read as limited to the described order or elements unless stated to that effect. In addition, use of the term “means” in any claim is intended to invoke 35 U.S.C. §112, ¶6, and any claim without the word “means” is not so intended.

What is claimed is:

1. A call status indicating method applicable to a user equipment comprising:
establishing a radio resource connection (RRC);
performing a subscriber authentication procedure in response to establishing the RRC connection;
transmitting or receiving a call setup message in which the call status is indicated within the call setup message in response to performing the subscriber authentication procedure; and
performing a radio bearer setup procedure in response to transmitting or receiving the call status embedded in the call setup message.

2. The method of claim 1, wherein the call status is indicated in an information element (IE) of the setup message.

3. The method of claim 2, wherein the call status is indicated within in Important Status IE of the setup message.

4. The method of claim 1, wherein establishing the radio resource connection (RRC) comprises:
receiving the call status;
generating the call setup message which comprises the call status;
establishing the RRC with a mobile originating establishment cause; and
transmitting the call status through the RRC.

5. The method of claim 1, wherein establishing the radio resource connection (RRC) comprises:
receiving a paging message;
establishing the RRC with a mobile terminating establishment cause in response to receiving the paging message;
receiving the call setup message through the RRC; and
obtaining the call status from the call setup message;

6. The method of claim 3, wherein the call status comprises three possible discrete levels of emergency, high, and low.

7. The method of claim 6, wherein the three possible discrete levels of emergency, high, and low are represented by three different bit values of the Important Status IE of the setup message.

8. The method of claim 4, wherein receiving the call status comprises:
receiving a phone number to be dialled, wherein the phone number comprises a pre-fix of a specific sequence of digits; and
mapping the pre-fix to the call status.

9. The method of claim 5 further comprises:
presenting the call status on a display of the user equipment with different visual representation for different call status.

10. The method of claim 5 further comprises:
presenting the call status on a display of the user equipment with different audio representation for different call status.

11. A user equipment comprising:
a transceiver for transmitting and receiving data;
a processor coupled to the transceiver and is configured for: establishing through the transceiver a radio resource connection (RRC), performing a subscriber authentication procedure in response to establishing the RRC connection through the transceiver, transmitting or receiving through the transceiver a call setup message in which the call status is indicated within the call setup message in response to performing the subscriber authentication procedure, and performing through the transceiver a radio bearer setup procedure in response to transmitting or receiving the call status embedded in the call setup message.

12. The UE of claim 11, wherein the call status is indicated in an information element (IE) of the setup message.

13. The UE of claim 12, wherein the call status is indicated within in Important Status IE of the setup message.

14. The UE of claim 11 further comprises an input unit configured for
receiving the call status, and the processor is configured for establishing the radio resource connection (RRC) further comprises: configured for generating the call setup message which comprises the call status, establishing through the transceiver the RRC with a mobile originating establishment cause, and transmitting through the transceiver the call status through the RRC.

15. The UE of claim 11, wherein the processor is configured for establishing the radio resource connection (RRC) further comprises:
receiving a paging message, establishing the RRC with a mobile terminating establishment cause in response to receiving the paging message, receiving the call setup message through the RRC, and obtaining the call status from the call setup message.

16. The UE of claim 13, wherein the call status comprises three possible discrete levels of emergency, high, and low.

17. The UE of claim 16, wherein the three possible discrete levels of emergency, high, and low are represented by three different bit values of the Important Status IE of the setup message.

18. The UE of claim 14, wherein the input unit receives the call status comprises:
receiving through the input unit a phone number to be dialled, wherein the phone number comprises a pre-fix of a specific sequence of digits; and the processor is further configured for mapping the pre-fix to the call status.

19. The UE of claim 15 further comprises a touch display, and the processor is further configured for:
presenting the call status on the touch display of the user equipment with different visual representation for different call status.

20. The UE of claim 15 further comprises an audio output unit, and the processor is further configured for:
presenting through the audio output unit the call status on a display of the user equipment with different audio representation for different call status.
